(19) United States
(12) Patent Application Publication
(10) Pub. No.: US 2009/0265437 A1
(43) Pub. Date: Oct. 22, 2009

(54) SYSTEM AND METHOD FOR IDENTIFYING AND MODIFYING INFLUENCERS AND STRESSORS

(76) Inventor: Eric Lucas, Minnetonka, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/107,575

(22) Filed: Apr. 22, 2008

(51) Int. Cl. G06F 15/16; G06F 17/30; G06F 3/048

(52) U.S. Cl. 709/206; 707/104.1; 715/780; 707/E17.044

(57) ABSTRACT

The present invention is directed to a method and system of managing stress comprising identifying factors with which a user interacts; listing the factors with which the user interacts into an inventory form; making notations and/or making journal entries into a journal form regarding experiences with the factors; entering the factors into a categorization grid, based at least in part on the notations and/or journal entries; and developing rules and a plan for reducing, changing or eliminating exposure to factors and/or impact of factors located in a negative category in the categorization grid and increasing exposure to factors and/or impact of factors located in a positive category in the categorization grid. The system is provided in electronic form as well as in paper form.

### FIELD OF THE DISCLOSURE

The present disclosure relates to the field of self-assessment, identifying influences and forces that affect behavioral characteristics and attitudes, and developing and implementing plans to address these influences and forces. More particularly, the present disclosure relates to a system of identifying factors and influencers that provide energy, positive effects or stimuli, or provide negative energy, effects or stimuli, categorizing these factors, developing a plan and implementing a plan to increase the positive stimuli and reduce the negative stimuli, to reduce the stress in one's life and increase the energy, spirit, optimism, wellness, and general attitude of an individual user. The examination and evaluation system herein is particularly well adapted for the development of plans to reduce stress and to focus on increasing positive life influences.

### BACKGROUND OF THE INVENTION

On a daily basis, an individual generally comes into contact with many forces from the outside world. These forces may come from one's surroundings, such as interactions with other people, as well as impacts from events, both local and worldwide. Major life changes, workplace issues, unpredictable events, personal fears, unrealistic expectations, and the like, can all impact a person's well-being and attitude. This interchange between a person and other people, places and things can have both positive and negative effects on a person. Oftentimes, if the effect is negative, these negative forces are labeled as stress-inducing forces.

Stress, at a certain level, is a natural part of life and the environment. In a stressful situation, a person may experience the “flight-or-fight” response in dealing with the circumstances. However, many stressful situations in the workplace, in relationships, at home, in general daily life, do not lend themselves to a simple, actual, “fight-or-flight” response. How an individual deals with the difficulties, challenges, and expectations of daily life, with so many potential stress-inducing factors, can affect an individual's health, confidence, attitude and general well-being. These stress-related effects can be prolonged, e.g. problems in the workplace or with a personal relationship, as compared to imminent attack by a wild animal, and exacerbate the “fight-or-flight” systems designed to deal with generally short-term stressful situations. Long-term exposure to stress can be considered chronic stress. The effects of chronic stress can be prolonged and problematic, when the stressor is of the nagging and unrelenting type. These stressors can build-up over time and can be persistent. These are also the types of stressors that affect many of the people experiencing chronic stress.

People respond to stress in many different ways; some positive and some more negative. In some circumstances, some people can become energized and use the stress-related energy to overcome obstacles and challenges, only to feel exhaustion after the fact. In similar circumstances, other people can experience a loss of energy and motivation. The symptoms of stress can vary with each individual and can be minor, such as suffering headaches, acne, and stomach upset, to more serious symptoms such as high blood pressure, chest pains and debilitating depression. Other, non-physical symptoms of stress can include feelings of insecurity, burn-out, worry, anxiety, irritability and broken relationships. Stress can affect productivity and ability to handle life's normal ups and downs. Generally, people feel less stress in environments and situations over which they can exercise some control and where the level of uncertainty is reduced.

A variety of methods and programs have been developed to help in the management of stress. Often, the program may include exercise to “burn-off” some of the stress, and may focus on nutrition, meditation and other relaxation techniques. The program may also focus on insuring adequate sleep and rest are obtained. In some cases, social support from friends, family, coaches, others going through similar experiences-through group meetings and the like, can be helpful. Professional assistance, such as psychotherapy, can also help people who are dealing with various forms of stress. Some programs suggest creating more life certainty by developing and keeping a daily routine, which may help alleviate some controllable sources of stress. The structure thus provided can assist in absorbing some of the “shocks” of the unexpected.

However, regardless of what type of method or program one chooses to assist in creating a life management system and in managing stress, it is important to try to understand the sources of one's stress. Without an understanding of one's stress sources, the focus on nutrition, exercise, rest and sleep, and the like, deals with the manifestations of stress and attempts to deal with the effects of stress. However, these programs do not look to the sources of stress as a means of managing stress. Hence, there is a need for a stress management process that considers the sources of stress as part of a life management system.

### SUMMARY OF THE DISCLOSURE

In one aspect, the present invention is directed to a method of managing stress that includes a user identifying entities or factors with which the user interacts; listing the factors and influences with which the user interacts in an inventory grid; making notations and/or making entries into a journal regarding experiences with the factor or influence; entering the factors and influences into a categorization grid; and developing a plan for reducing, changing or eliminating the exposure to factors/influences and/or the impact of factors/influences located in a negative category in the categorization grid and increasing exposure to factors/influences and/or the impact of factors/influences located in a positive category in the categorization grid. The factors/influences generally represent people, places and things. The method can be practiced through electronic input through the Internet or, alternatively, through paper copies of the various method documents. The method described above provides for coaching, should a user of the method desire coaching. Coaching can be provided electronically, telephonically or in-person. Further, the method also facilitates communication among users of the method, typically through e-mail and/or through an on-line chat room.

In another aspect, the present invention is directed to a life management system wherein the system comprises a set of forms to assist the user in identifying negative and positive factors or influences, and developing a plan to increase the positive factors and eliminate or reduce the negative factors. The system includes an inventory form, a journaling form, and a categorization grid. The system is available electronically through the Internet, DVD, CD-ROM or through paper copies. The Internet-based system includes subscriber registration and validation software, as well as the on-line forms for a subscriber to input and categorize factors or influences with which the subscriber interacts. The completed on-line forms and plans can be stored in a database for later access and updating by an individual subscriber through the use of a password. A coaching module facilitating electronic-based communication with the subscriber and a module for facilitating electronic-based communication among subscribers is also part of the Internet-based system. Coaching and inter-subscriber communication is also possible through telephonic means as well as in-person.

In another aspect, the present invention is directed to a stress-management system wherein the system comprises a set of forms to assist the user in identifying negative and positive factors or influences, and developing a plan to increase the positive factors and eliminate or reduce the negative factors. The system includes an inventory form wherein the user lists the factors and influences the user come into contact with; a journaling form for noting, for example, experiences associated with a particular factor or influence; and a form for categorizing the factors and influences as negative (red/carbon monoxide; yellow/carbon dioxide) or positive (green/oxygen). The system is available electronically through the Internet, DVD, CD-ROM, or through paper copies. The Internet-based system includes subscriber registration and validation software, as well as the on-line forms for a subscriber to input and categorize factors and influences with which the subscriber interacts. The completed on-line forms and plans can be stored in a database for later access and updating by an individual subscriber through the use of a password. A coaching module facilitating electronic-based communication with the subscriber and a module for facilitating electronic-based communication among subscribers is also part of the Internet-based system. Coaching and inter-subscriber communication is also possible through telephonic means as well as in-person.

### BRIEF DESCRIPTION OF THE DRAWINGS

These as well as other objects and advantages of this invention will be more completely understood and appreciated by referring to the following more detailed description of the presently preferred exemplary embodiments of the invention in conjunction with the accompanying drawings, of which:

FIG. 1 is a flow chart of the basic steps in the core system.

FIG. 2 is an embodiment of an inventory worksheet.

FIG. 3 is an embodiment of a journal page of the system.

FIG. 4 is an embodiment of a journal page including categorization of entries.

FIG. 5 is an embodiment of a page for categorizing input from the journal page and inventory worksheet.

FIG. 6 is an embodiment of the “Oxygen Plan”, adapted for rule setting, and facilitating setting limits and developing guidelines for activities with respect to factors and influencers identified in a categorization grid.

FIG. 7 is an embodiment of the “Oxygen Plan”, that is, an action plan to respond to the factors identified in the various categories.

FIG. 8 is a flow chart of an embodiment of a web-based version of the core system.

FIG. 9 is an example of an information screen from the web-based system.

FIG. 10 is another example of an information screen from the web-based system.

FIG. 11 is another example of an information screen from the web-based system.

FIG. 12 is another example of an information screen from the web-based system.

FIG. 13 is another example of an information screen from the web-based system.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

### DETAILED DESCRIPTION OF THE DISCLOSURE

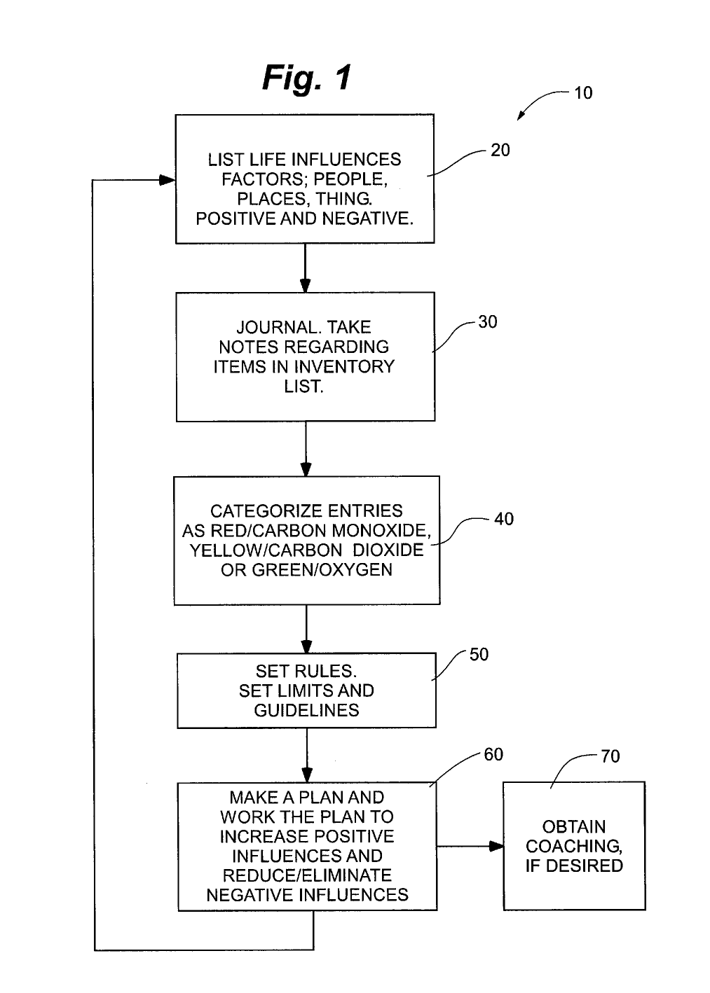

As illustrated in FIG. 1, the flow diagram presents the core of the method for producing an individualized plan to identify sources that influence one's life, especially stress inducing and energy draining sources; categorize the various sources as positive or negative factors; and identify steps to increase the positive factors and reduce, control or remove the negative factors. The system uses the metaphor of the need for breathing, for oxygen, for humans to survive and thrive, as a vehicle of understanding the system and the requirements of the system. Oxygen is generally understood as a necessary part of living and surviving. Without oxygen, a human can not live for very long, and fouled oxygen (polluted air) can cause discomfort and difficulty breathing, resulting in lowered quality of life. Reduction of intake of oxygen or lack of oxygen can cause dizziness, discomfort, and ultimately death. Therefore, oxygen is identified as a positive factor in the instant system. Oxygen is associated with the color green as good, positive, “go”, a desired state. Oxygen or the color green is associated with factors that provide energy, confidence, spirit, happiness, optimism and general well-being. These positive factors assist in dealing with other factors that cause stress.

Carbon dioxide is generally understood as a negative factor. Carbon dioxide is a product of respiration and, when inhaled at higher than usual atmospheric levels, causes a sour taste in the mouth and stinging in the nose and throat; both uncomfortable sensations. Breathing at low concentrations of carbon dioxide can cause drowsiness, headache, nausea, and general discomfort. Concentrations of carbon dioxide above 5,000 ppm are very unhealthy and concentrations above 50,000 ppm are dangerous to animal and human life. Carbon dioxide is associated with the color yellow or amber, indicating caution and attention are required; all is not well. Factors associated with the carbon dioxide category or yellow category are factors that are not positive, but also are not debilitating. These factors tend to drain energy, confidence, spirit, happiness, optimism and well-being; are a general drain on daily attitude. These factors are factors that are manageable and should be reduced or changed to improve well-being and reduce stress.

The third category is represented by carbon monoxide, which is generally understood to be harmful to humans. Carbon monoxide in lower levels can cause dizziness, loss of consciousness, and toxicity to the human nervous system. At higher levels, carbon monoxide can cause death. The public is generally aware of the dangers of carbon monoxide, as every year there are several deaths attributed to carbon monoxide poisoning and each home is recommended (in some areas, required) to contain at least one carbon monoxide detector. Carbon monoxide is associated with the color red, indicating danger and attention is immediately required; all is not well. Factors associated with the carbon monoxide category or red category are factors that are negative and can be debilitating. These factors tend to kill energy, confidence, spirit, happiness, optimism and wellness. These red factors tend to take a toll on daily attitude. The carbon monoxide (red) factors are factors that must be reduced or eliminated to improve well-being and reduce stress.

The systemized process 10 is designed to assist the user in removing or controlling the negative factors impacting the user's life and identifying and promoting the positive factors in the user's life, to result in a happier, more confident, energetic, optimistic, positive and productive individual. The general process is shown in FIG. 1. As illustrated in FIG. 1, the first step 20 of the process 10 is to take inventory or to make an accounting of the various influencers and factors that can have an impact on the user, or with which the user comes into contact. The list of life influences and factors includes positive and negative influences. Generally, the life influences fall into one of the categories of people, places or things. The next step 30 of the process 10 requires thinking about each of the factors/influences listed in the previous inventory step 20, and writing comments and observations about factors/influences in the list. The comments can include recalling incidents and memories involving the factor/influence, feelings about or toward the factor/influence, and the like.

After the observation and note-taking step 30 of the process is substantially completed, the next step 40 of the process 10 is to categorize the factors/influences identified in the previous step 30 as positive (green/oxygen), neutral to mildly negative (yellow/carbon dioxide), or negative to strongly negative (red/carbon monoxide). Once the various factors/influences have been categorized 40, the next step is to set rules 50. The set rules activities 50 can include deciding which factors/influences to deal with first and deciding how to deal with those factors/influences. The set rules step 50 can include deciding how much time will be spent with a difficult person or how often a positive experience (e.g. a walk, a fun telephone conversation, time spent reading, and the like) will be included. The next step of the process 10 is to make a plan and to implement the plan 60. The plan 60 can include detailed steps and timeframes in addressing the various factors/influences listed in previous steps 30, 40. Generally, the plan should increase positive (green/oxygen) factors/influences or impact of positive factors/influences; reduce or change somewhat negative factors/influences (yellow/carbon dioxide); and reduce or eliminate negative factors/influences (red/carbon monoxide). The plan can include actions such as increasing the amount of time for reading per week by a specific amount; limiting the topics of conversation with a negative co-worker where a practiced phrase is used to change the subject/end the topic; taking steps to eliminate an abusive relationship such as identifying agencies that can provide help and support, for example. Actions are taken that follow the plan that has been developed, and can include overt actions, as noted above, as well as conscious changes in attitude and perspective. Coaching 70 is available during the process 10, to assist in the various steps of the process 10.

Once the process 10 has been practiced once, the process 10 can be repeated as often as desired. The entire process 10 can be repeated, or the process 10 can be joined at any place. For example, influences can be re-categorized 40, or the plan 60 can be updated and the revised plan implemented.

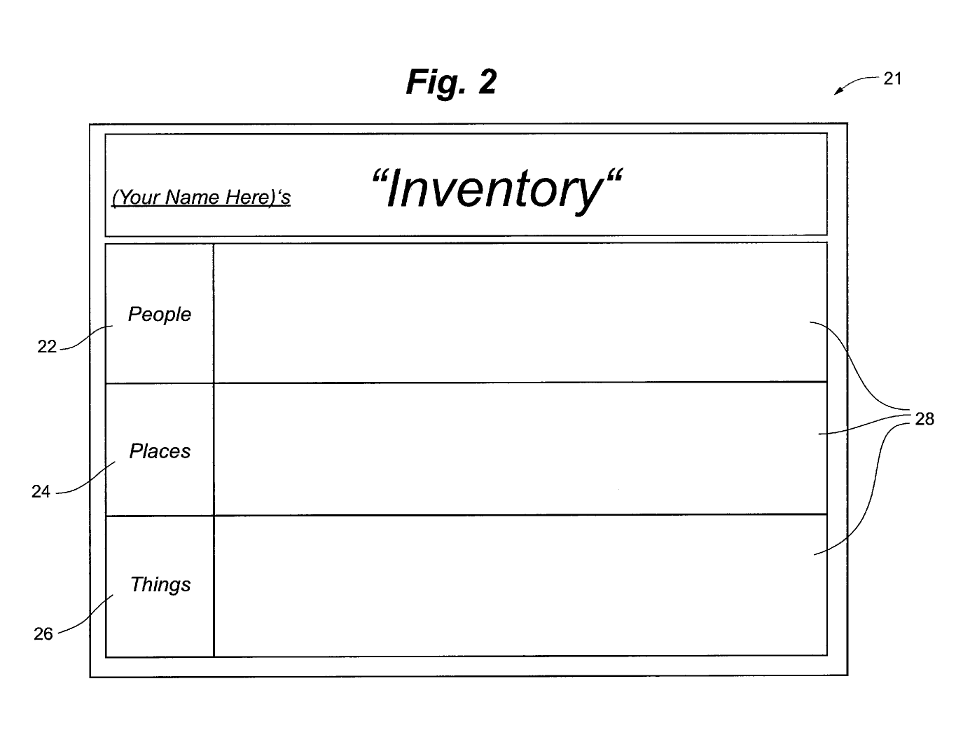

FIG. 2 is an example of an inventory worksheet, separated into the categories of people 22, places 24 and things 26. The user completes the “people” inventory 22 by listing the various people with whom the user is in contact. The contact can be daily contact, such as contact with a co-worker, a family member, a boyfriend or girlfriend, significant other, and the like. However, the contact need not be daily, and can be as little as once a year, for example, seeing a family member only once a year or so at a holiday gathering or other family event. To be listed in the people category 22, contact does not need to be daily or even weekly. The significance of the people category 22 is for the user to list those people the user is in contact with, on any basis. The people category 22 can include family members, employees, co-workers, bosses, employer, friends, teachers, students, members of the same organization, store clerks, care-givers, and any other person with whom the user comes into contact. On a given day, the user can even list a stranger who, for example, held the door, as the user carried in an armload of boxes. Because the process is iterative, the people listed in the people category 22 can change.

The second category, “places” 24, is designed to stimulate the user to think about and consider the various places that the user travels to, has been to, or passes through. The “places” 24 can include places such as the home, car, bus or other mode of transportation that is taken to and from the workplace, school, workplace, gym, favorite meeting places with friends, coffee shops, shops, parks, and so on. The “places” category 24 also includes places that are not necessarily visited on a daily, weekly or a monthly basis, such as the home of other family members, home of a friend, vacation spots, weekend getaways, such as a cabin or resort, and so on. The place 24 does not need to have been recently visited by the user, and simply can bring to mind either a pleasant or unpleasant memory. Places to consider for listing in the category can generally include places that are work-related, family- related and leisure-related.

The third category, “things” 26, is a broad category for the user to consider various things in their life that can make a positive or a negative impact on their attitude and outlook. Things 26 can include items such as food related “things”; sweets, high fat foods, favorite foods, alcoholic beverages, other beverages, and the like. Things 26 can include smoking, drinking, drug-use, homework, housework, care-giving, organizations, events, weight, self-image, noisy neighbors, bills, traffic, dating, television, movies, exercise, fresh air, flowers, books, cars, pets, and so on. The things 26 included in the category can include more intangible “things” such as responsibilities and relationships, however, it is helpful to be more specific and identify the “thing” associated with, for example, the responsibility (e.g. requirement to pick-up children from daycare by a certain time, or to retire a debt by a certain date). The “things” 26 that are listed in this category can include pleasurable things, favorite things, unpleasant things, things one is trying to avoid and so on. The category is very broad and is not to be restricted, but is open to the variety of things 26 that can impact the user's life and attitude.

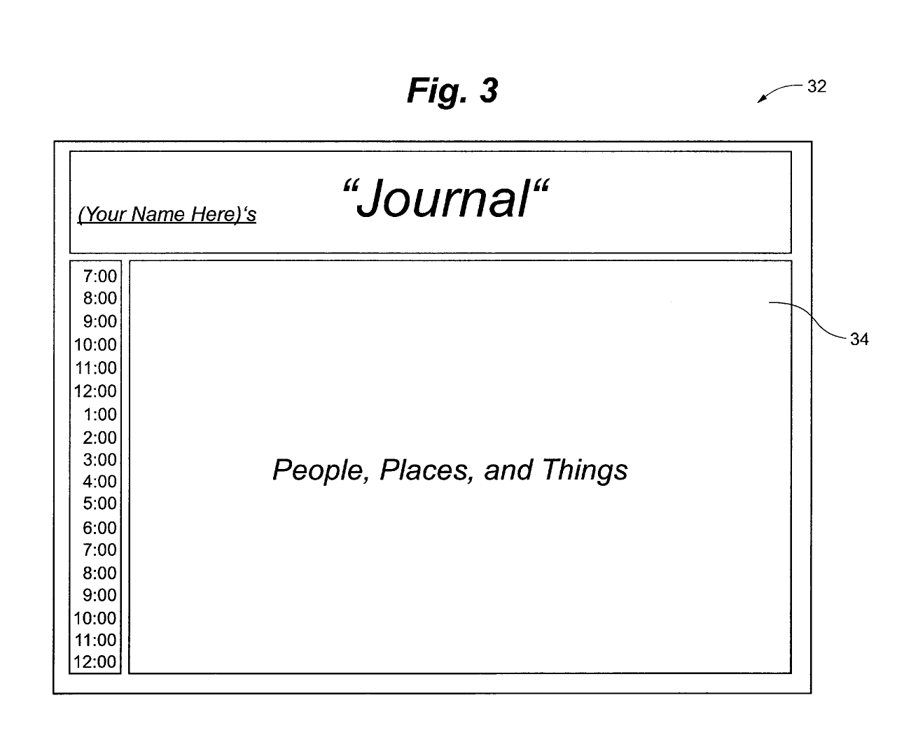

As noted in the flow chart of FIG. 1, the next step of the process is for the user to become more aware of the people 22, places 24 and things 26 in his/her life and to eventually determine if these factors are positive or negative factors and stimuli. To facilitate a better understanding of the people 22, places 24 and things 26 that comprise the constellation of influences and forces in a user's environment, the user is requested to keep a daily record 32 or journal of the people 22, places 24 and things 26 that come into the user's sphere of experience or contact during a given day. During the journaling exercise 30 the user is requested to simply note 34 the people 22, places 24 and things 26 the user comes into contact with at different times of the day and evening. FIG. 3 provides an example of a journal page 32.

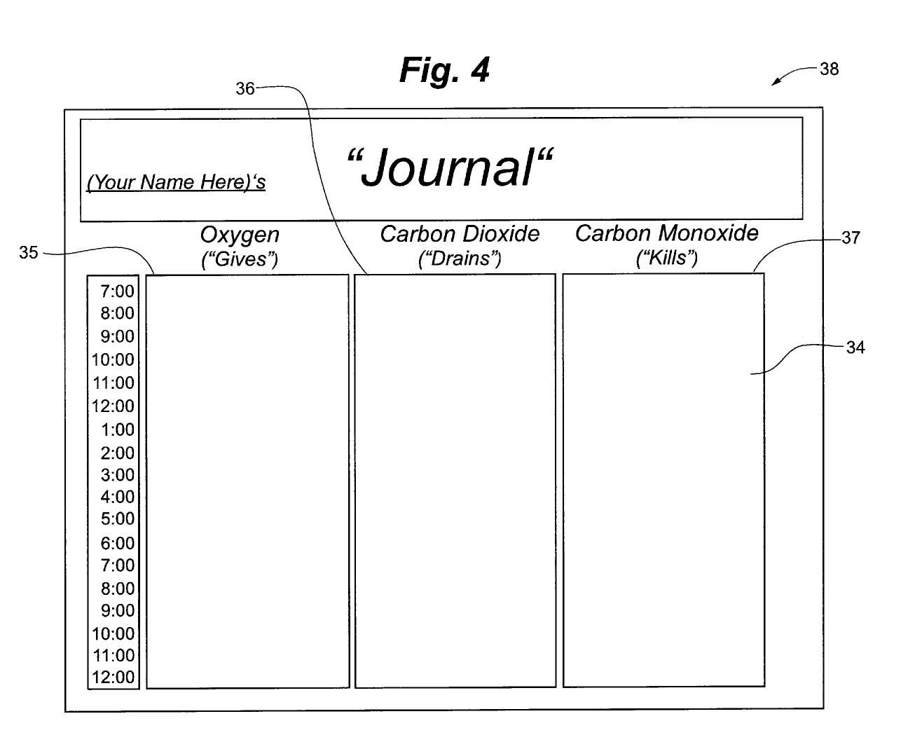

The user is invited to note incidents and events in the journal 32, as well as people 22, places 24 and things 26. However, at this point, there is no attempt to judge the people 22, places 24 or things 26 as positive, negative, or neutral, but only to list them to categorize at a future time. The journaling effort of the user can span one day or can include several days in one week to provide the breadth of different activities so that people 22, places 24 and things 26 that are encountered are reasonably representative of the user's general experience. It is important to note that the people 22, places 24 and things 26 do not necessarily need to be experienced in person but can be experienced through telecommunications or written form. Because the journal entries 34 do not require any type of evaluation, the journal 32 can range from very detailed notations regarding people 22, places 24 and things 26 or can simply be a jotting down or list of people 22, places 24 and things 26. Alternatively, the user can choose to categorize the journal entries 34 as the entries are made. In this case the user can choose to use the journal entry format 38 shown in FIG. 4.

The journal entry 34 format 38 in FIG. 4 comprises three columns in which to categorize the previously identified people 22, places 24, and things 26. The first column 35 is identified with the heading “Oxygen” with the sub-heading “Gives”. Other similar headings are contemplated. Those people 22, places 24 and/or things 26 that are positive, provide energy, optimism, and a sense of well-being are listed in the first column 35. In a color-coded journal 32, the column 35 is colored green. The second column 36 is identified with the heading “Carbon Dioxide” with the sub-heading “Drains”. Other similar headings are contemplated. Those people 22, places 24 and/or things 26 that are somewhat negative, drain energy, reduce optimism, and diminish the sense of well-being are listed in the second column 36. In a color-coded journal 32, the column 36 is colored yellow. The third column 37 is identified with the heading “Carbon Monoxide” with the sub-heading “Kills”. Other similar headings are contemplated. Those people 22, places 24 and/or things 26 that are negative, crush energy, defeat optimism, and destroy a sense of well-being are listed in the third column 37. In a color-coded journal 32, the column 37 is colored red.

The next step of the system 10 is to categorize 40 the people 22, places 24 and things 26 that have been accumulated through the journaling step 30 and the inventory step 20 into various categories. Generally, it is expected that the journaling process 30 may identify people 22, places 24 or things 26 that may have been overlooked during the inventory step 20. The combination of the results from the inventory step 20 and the journaling step 30 is expected to provide a solid basis for moving to the next step of the process 10.

As previously noted, the system 10 uses readily understandable terms to identify the categories 42 into which the people 22, places 24 and things 26 identified during the inventory step 20 and the journaling step 30 are to be put into. The people 22, places 24 and things 26 that provide the user with optimism, pleasurable memories, confidence, are energizing, and the like are placed in the oxygen or green category 35. Those people 22, places 24 and things 26 that the user finds draining; that negatively impact the user's energy, confidence, optimism, and the like, are placed in the yellow or carbon dioxide category 36. Those people 22, places 24 and things 26 that most negatively impact the user (“can kill one's energy, confidence, and spirit”) are placed in the red or carbon monoxide category 37.

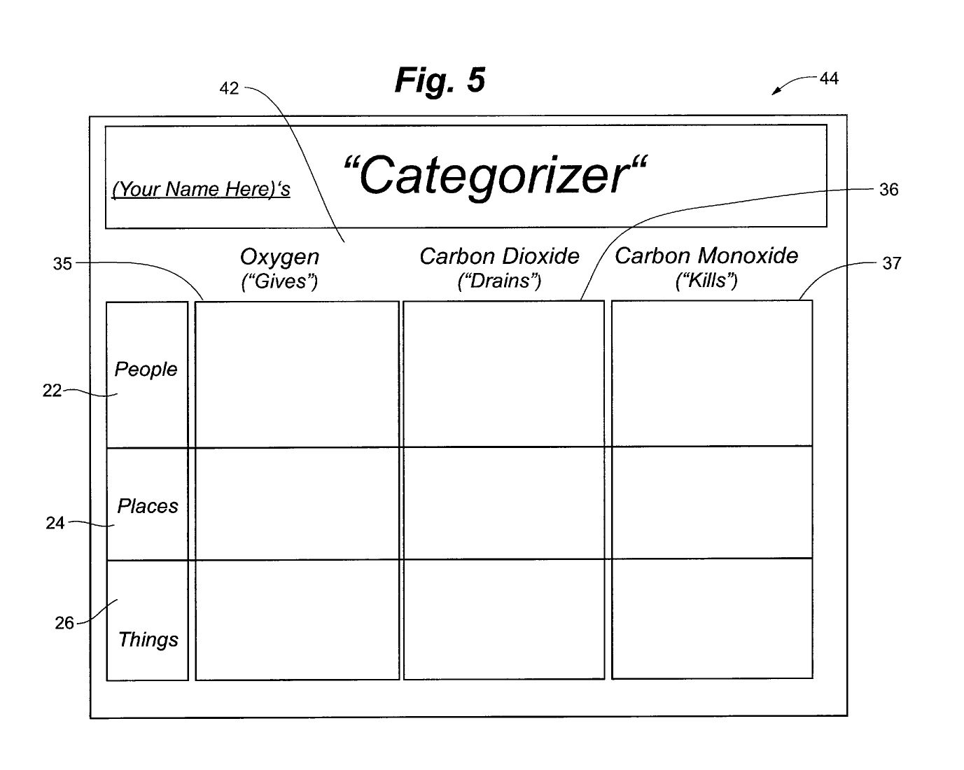

As noted above and in FIG. 5, the first category 35 is the category identified as oxygen or green 35. The oxygen category 35 includes those people 22, places 24 and things 26 that the user identifies as positive. These people 22, places 24 and things 26 give energy, provide confidence, spirit, happiness, optimism, wellness, and energize the user's life and attitude. For example, the user may place a particular friend in the oxygen category 35, because the friend is generally upbeat, helpful, listens, provides good counsel, or is just fun to be around. The user may put a particular place in the oxygen category 35, for instance if the place provides as sense of well-being (e.g. a favorite walk through a park, wood, or along a beach or river) or prompts a pleasant memory (e.g. special outing with a child, spouse, parent, friend). Or, alternatively, a particular thing, such as fishing or bicycling may be put in the oxygen category 35 as providing an energizing or positive experience.

The second category 36 is the carbon dioxide category 36, and is identified as containing those things that drain the user's energy, confidence, spirit, happiness, optimism and wellness. The carbon dioxide category 36 is identified by the color yellow, and emphasizes the note of caution sounded regarding the factors identified in this category. For example, the user may place a co-worker in the carbon dioxide category 36 if the co-worker is difficult to work with, complains, and/or cannot be trusted. Further, a place may be placed in the carbon dioxide category 36 if the place is an energy drainer, for example, if the user is a member of a religious organization or church, or any organization, whose message or activities no longer resonate with the user; or the place is a relative's home that is the trigger for recalling negative or painful memories.

The third category 37 is the carbon monoxide category 37 for organizing the items identified in the inventory 20 and journaling 30 steps and represents those items that “kill” the user's confidence, spirit, happiness, optimism, and wellness. Hence, the carbon monoxide category 37 is colored red as a strong warning that this category needs significant attention. The user may place school in the carbon monoxide category 37 if, for example, the user dreads going to school because of bullying, lack of popularity, or failing grades. Or, the user may be in an abusive relationship and has put the “significant other” in the carbon monoxide category 37. As another example, the user may put smoking or sweets in the carbon monoxide category 37 if the smoking is causing health problems and potentially death, or if the sweets have led to obesity or if the user is diabetic.

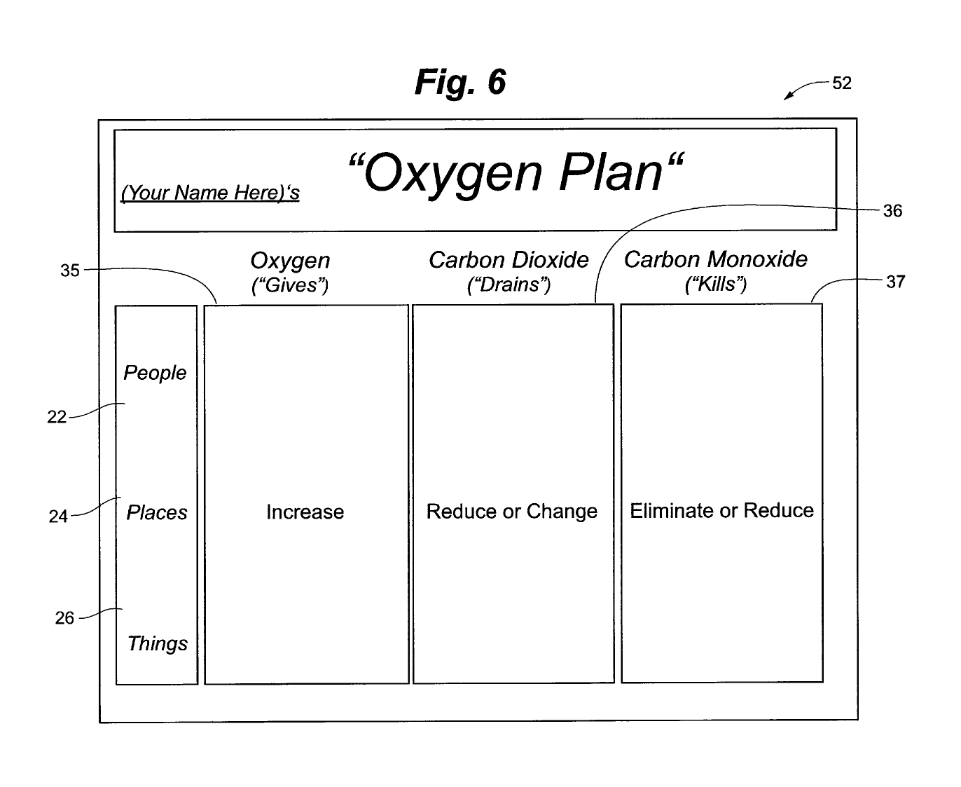

Once the inventory entries 28 and the journal entries 34 have been categorized, the next step, as noted in FIG. 1, is to set rules 50 around the entries 28, 34 in the various categories. The rules 50 typically set parameters for activities (e.g. limit discussion of topic X with co-worker) and the plan 60 provides the “how”, the specific actions to be taken within the established rule 50. FIG. 6 provides a form 52, a way of organizing the rules, limits, guidelines with respect to the factors listed in the categorization form shown in FIG. 5.

Generally, the factors in the oxygen category 35 are factors that the user should endeavor to increase. The factors identified in the oxygen category 35 are those positive factors that provide energy, optimism, confidence, spirit, pleasure, and general well-being. These are the factors, and perhaps similar factors, the user should endeavor to include in his/her life and to increase in his/her life. The user is charged with developing a plan 50 whereby these identified positive factors can be focused upon, expanded, fostered, and improved, to continue to provide the energy and well-being that they already provide, and to perhaps increase the benefits that are provided. Focusing and expanding the factors in the oxygen category 35 is one way of reducing stress, as these various positives contribute to the user's energy and positive attitude.

The factors identified in the carbon dioxide or yellow category 36 are those factors that require reduction or change. It is understood that there are those factors that may not be able to be eliminated that are energy and attitude drains that contribute to stress. However, awareness of these factors, and developing a plan 60 to reduce or change these factors, contributes to a sense of control, of being able to lessen the effects of the factors on the user's well-being and attitude. The user is to develop a plan 60 for each of the factors in the carbon monoxide category 36, identifying real steps (the “how”) that the user can take to either reduce the effects of the factor or change the factor (or change the effects of the factor) or the user's attitude towards the factor. The plan development process 60 includes a reflection as to what the user can change in or about the factor, what the user cannot change but may be able to reduce about the factor, and what the user may change about his/her own attitude about the factor.

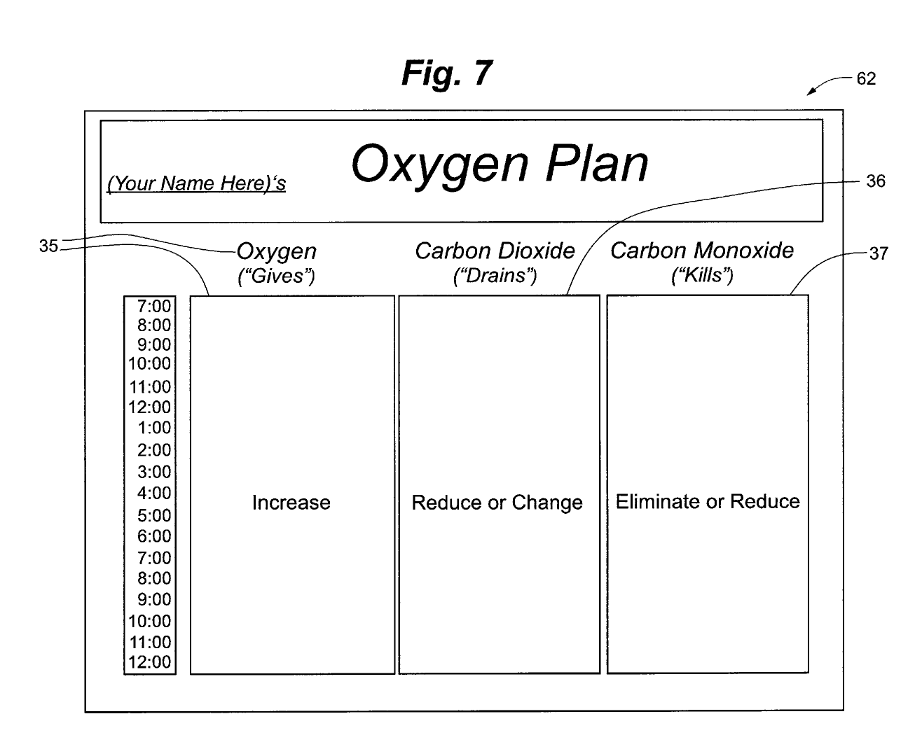

The factors identified in the carbon monoxide 37 or red category 37 are those factors that require reduction or elimination. The carbon monoxide factors are serious negative influencers on the user and the user's well-being, and these factors are to be reduced or eliminated. Here, too, the user is to develop a plan to deal with the factors in the carbon monoxide category. These factors may have the most impact on the user's stress level and well-being, may require the greatest thought and planning, may be the longest to accomplish, and may be the most difficult to accomplish. However, the elimination or reduction of one of these factors may have a profound impact on the user's attitude, energy, well-being and stress level. Hence, the user is encouraged to spend considerable time on this category, with the knowledge that the desired outcome may not come quickly. FIG. 7 provides a form 62 that can be used to develop and memorialize plans for implementation. The plans can be detailed enough to include a calendar with timeframes and times for implementing the plans.

The next step in the process 10 is to implement the various plans 60 that have been developed, and after an appropriate period of time, to repeat the process 10. The process 10 can be repeated from the beginning, or be re-entered at any point of the process 10. Repetition of the process 10 affords the user an opportunity to determine what improvements have been made, by comparing initial and subsequent inventories 20, categorizations 40 and plans 60. Further, the user can also determine which factors require further work, and may identify new factors.

The system described above can be implemented through Internet web-based delivery, wherein the user accesses a web-site that provides the various tools described above. Once the user registers, the user can create his/her own home page, which can be accessed when the user logs onto the system web-site. Alternatively, the various tools may be provided in workbook or other paper form, on DVD, or on CD-ROM. If the user chooses to use the web-based product, the user has the capability of printing-out the blank or completed forms for reference away from a computer terminal or other connecting electronic device.

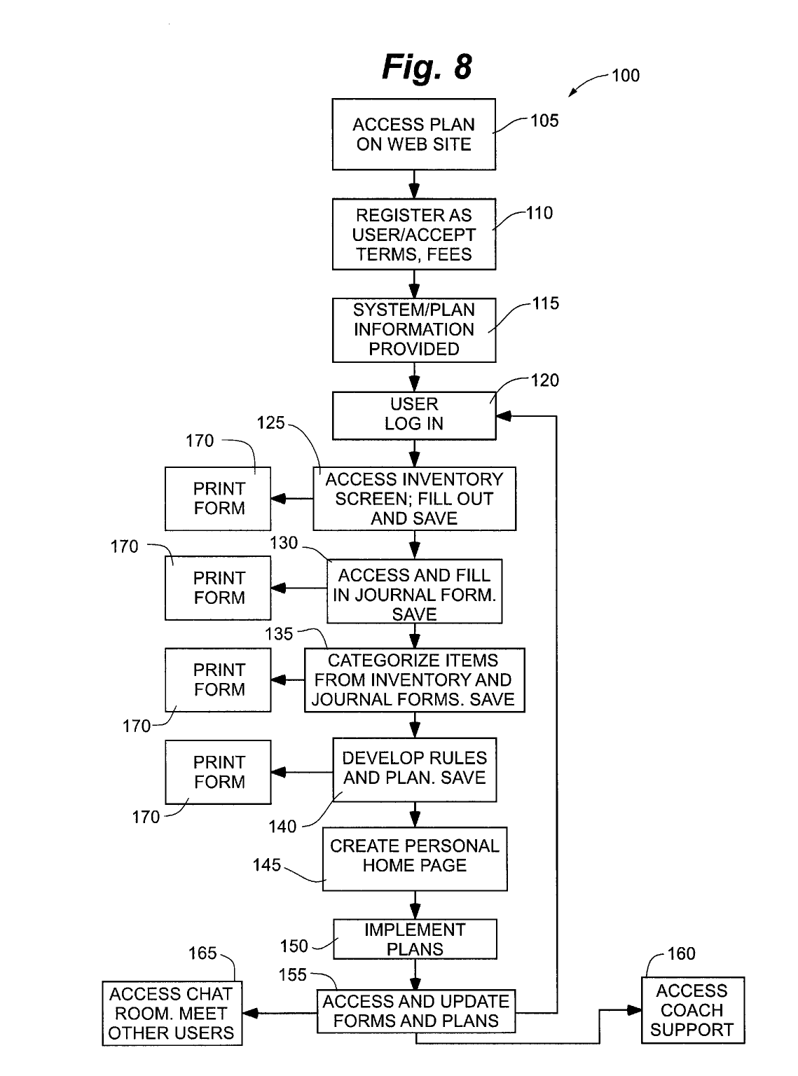

FIG. 8 illustrates the above described stress-reduction system 10, when the system is accessed through an Internet web-site. The home page of the web-site housing the stress-reduction system 100 includes an explanation of the system 105, including defining the various terms used in the system and the steps comprising the system. The user accesses the home page 105 of the web-site housing the stress-reduction system 100, and enters the user's log-in identification and password 120. If the user is a first-time user, the user will be prompted to register 110. The registration screen(s) provides the user with a form to fill-out and method of payment information, as well as terms and conditions 1 10. If the user chooses to continue, the user information is required, payment is required, and a log-in identification and password must be chosen. Once the user is registered, the user has access to the various screens comprising the stress-reduction system 100.

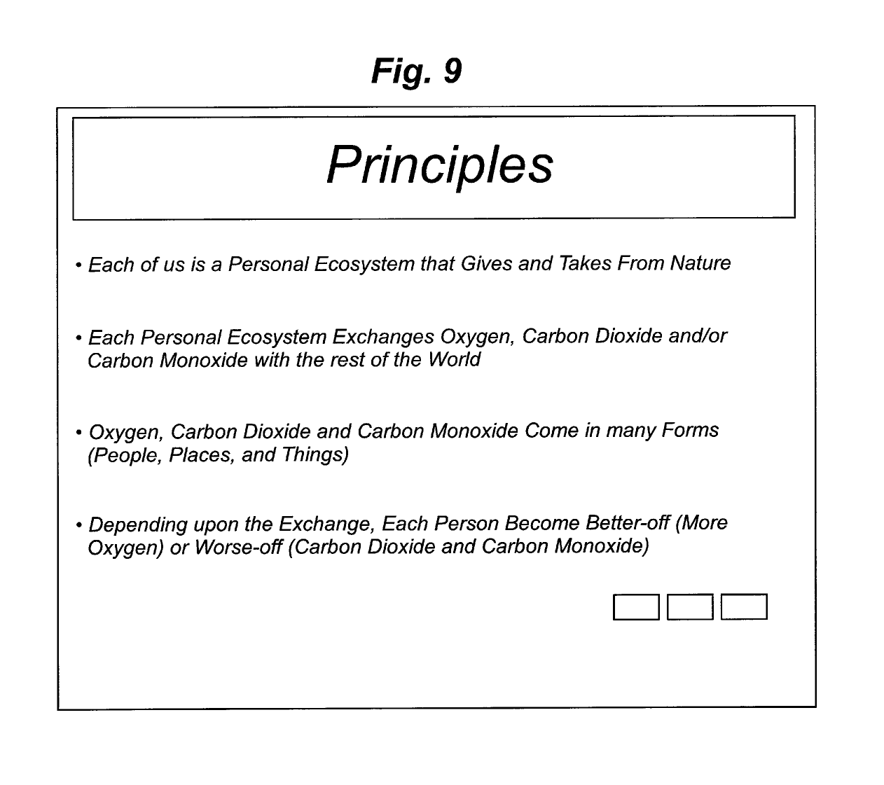

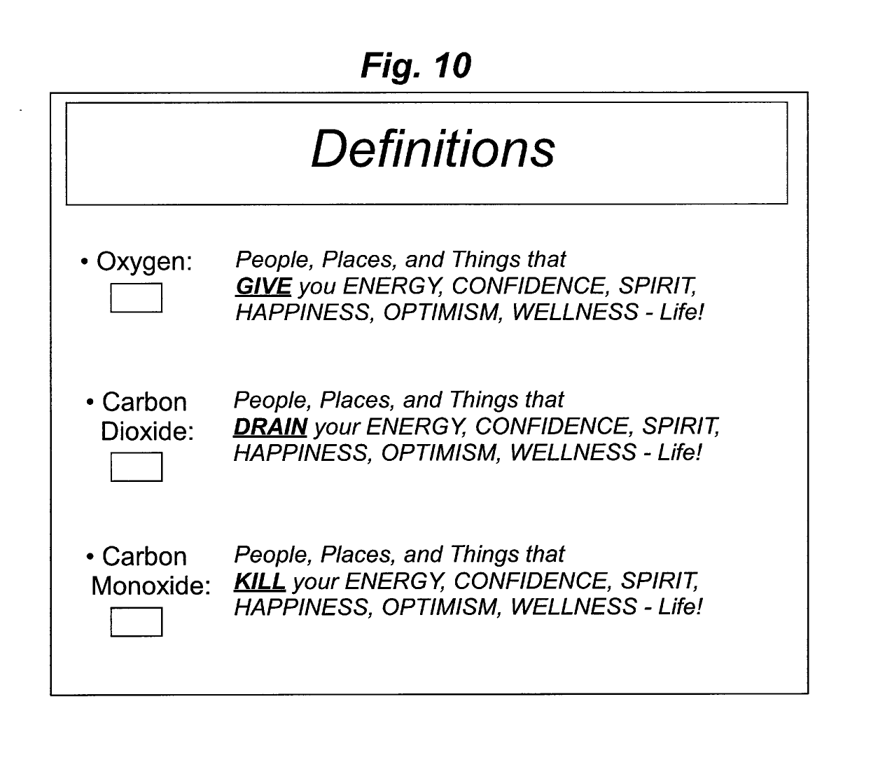

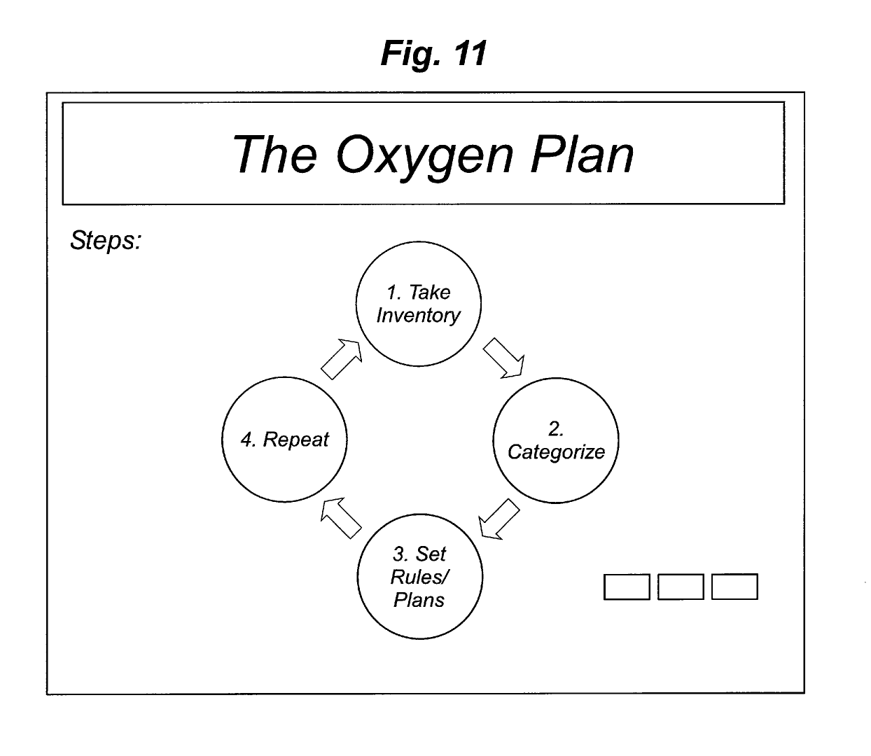

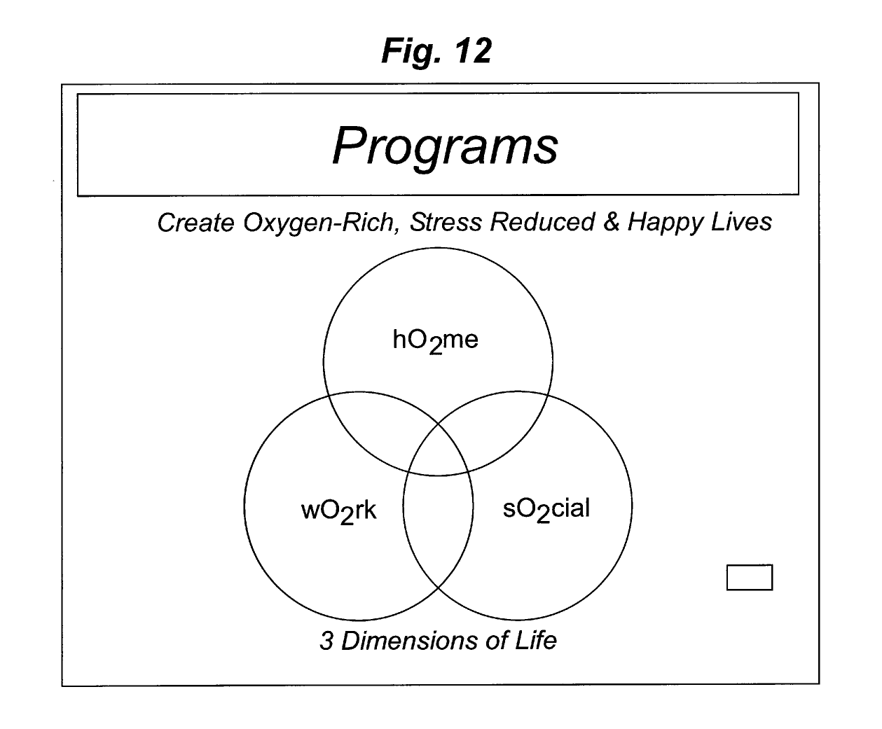

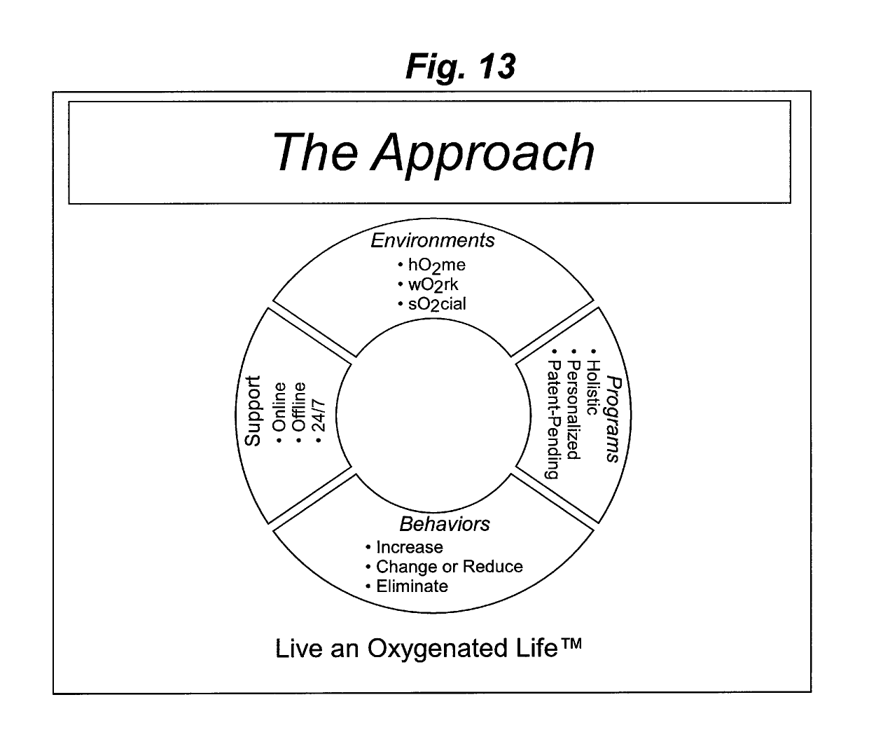

The screens comprising the Internet-based system 100 mirror the materials presented above, in the general description of the system 10. The forms are the same, but in electronic format; the meaning of the terms used in the forms is the same, and the forms are fill-in in a similar manner. Initial screens present background regarding the system 105, 115, the general outline and process of the system 105, 115, and instructions regarding the system and forms 105, 115. The user is encouraged to review the various initial screens and to understand the definitions as used within the confines of the system 100. Examples of information that is provided on initial screens of the web-based system are presented in FIGS. 9-13.

As in the system 10 described above, the user is prompted to fill-out an inventory 125 with respect to people 22, places 24, and things 26. The web-based system 100 includes explanations and directions as to the type of information that is to be filled-in 115, in the various electronic forms comprising the system 100. The inventory form 21 contains various structure to prompt and to assist the user in filling-in the inventory form 21. Once the inventory form 21 is filled-in, the completed form can be saved in the user's account 145. The user has the option to print the blank and/or the completed forms 170.

The user will be prompted to continue, and to begin to fill-in the journal form 32. This form, as well as the various other forms, can be saved in the user's account 145 and can be accessed by the user as often and when desired 155. For example, the user may begin to fill-in the journal form 32 for the day, approximately “real-time”. However, during a work day or just a generally busy day, filling-out the journal form 32 “real-time” may not be possible. The user is able to access the journal form 32 when time is available, and to update the form as desired 130. The journal form 32 also contains structure to prompt and assist the user in filling-in the form. The general journal form 32 of FIG. 3 can be used or the journal form 38 of FIG. 4, which allows for categorization the journal entries 34, can be used.

The user can choose to categorize the journal entries 34 as the journal entries 34 are being made, and such a form 38 is available in the system. The journal categorizer form 38 includes structure to assist the user in organizing the input from the journal form 32, or journal entries 34 can be made directly on the journal categorizer form 38. The first column 35 of the categorizing journal form 38 is identified with the heading “Oxygen” with the sub-heading “Gives”. Those people 22, places 24 and/or things 26 that are positive, provide energy, optimism, and a sense of well-being are listed in the first column 35. In a color-coded journal 38, the column 35 is colored green. The second column 36 is identified with the heading “Carbon Dioxide” with the sub-heading “Drains”. Those people 22, places 24 and/or things 26 that are somewhat negative, drain energy, reduce optimism, and diminish the sense of well-being are listed in the second column 36. In a color-coded journal 38, the column 36 is colored yellow. The third column 37 is identified with the heading “Carbon Monoxide” with the sub-heading “Kills”. Those people 22, places 24 and/or things 26 that are negative, crush energy, defeat optimism, and destroy a sense of well-being are listed in the third column 37. In a color-coded journal 38, the column 37 is colored red. Other alternative headings are contemplated.

If the general journal form 32 is used, then once the journal form 32 is completed for a specified period of time the user accesses the inventory form 21 and the journal form 32, and begins the process of categorizing the factors listed in the two forms in the categorizer form 44. The categorizer form 44 also includes structure to assist the user to fill-in the form. Factors from the journal form 32 and from the inventory form 21 can be cut and pasted to the categorizer form 44, or alternatively, can be entered onto the categorizer form 44 directly. The categorizer form 44, for example, is designed containing rows labeled “People” 22, “Places” 24 and “Things” 26, and columns labeled “Oxygen (“Gives”)” 35 (color-coded green), “Carbon Dioxide (“Drains”)” 36 (color-coded yellow), and “Carbon Monoxide (“Kills”)” 37 (color-coded red), to organize the user's information and to assist in providing clarity of input. The meanings associated with the columns and rows are the same as for the categorizing journal form 38. However, the presented forms are shown as examples of one embodiment of the system and the exact structure and content of each form can be varied.

Once the input from the journal (journal form 32 or journal categorizer form 38) and the inventory (inventory form 21) are input into the categorizer form(s) 44, the user is to develop rules and plans 140 to increase the “Oxygen” factors, reduce or change the “Carbon Dioxide” factors, and to eliminate or reduce the “Carbon Monoxide” factors. The “Oxygen Plan” forms 52, 62 contain structure to assist the user in developing these plans.

The first step of the implementation part of the process 100 is to set rules around the entries 28, 34, in the various categories on the categorization 44 form. The factors or influences identified in the columns marked “Oxygen”, “Carbon Dioxide” and “Carbon Monoxide” are considered, each individually. A rule is set for each of the factors listed on the categorization form 44. The rules typically set parameters for activities associated with identified factors or influences (e.g. limit discussion of topic X with co-worker; if Y begins to happen at a relative's house, politely withdraw; make sure to schedule at least 2 hours of reading for pleasure time per week; get help within 2 weeks to start improving performance in math class; contact search firm to investigate other employment options within 1 week; and so on).

Once the more general and guiding rules have been set, more detailed plans are developed to implement the rules. The plans provide the “how”, the specific actions to be taken within the established rule. For example, the plan can involve identifying resources that can help improve understanding of certain mathematical concepts such as tutors, teachers, learning centers, and so on; making contact; evaluating the options; selecting an option; engaging the particular option chosen; and scheduling time with the selected resource. In another example, the plan can involve writing down words to say when a recurring and expected interaction takes place, and practicing the words and alternative follow-up conversations.

The user can update or revise the plans as desired, and as with the other documents, can save the plan in the user's account. The next step for the user is to implement the various plans. The user can use the “Oxygen Plan” forms 52, 62 to update plans, make notations as to what has been accomplished, revise plans, and the like.

The user can repeat the process, by accessing blank copies of the various forms, and beginning the process again. Alternatively, the user can continue to modify and update the previously completed forms and plans. Further, the user has the ability to communicate electronically with other users through e-mail and/or access to an Internet chat room of other users of the method (“Oxygen Plan” users), to compare experiences, obtain perspectives, share successes, share their various journeys in the desire to reduce the stress in their respective lives. The plan users may find it useful to find others with similar categorizations, similar inventory items, and/or similar implementation plans, to share similar experiences and successes, to discuss similar issues and problems, to strategize plans, to act as a sounding board, and the like. Complementary categorizations may assist one user in learning from another user about strategies that proved useful and successful in dealing with certain people, places or things. The chat room also provides general user support.

If the user so chooses, the user may make it known that a coach or coaching 160 is desired. The user, when accessing the system electronically through the Internet, can click on the appropriate tab or button to indicate that the user would like to access the coaching option 160. The user communicates what type of coaching service 160 is desired and at what frequency. Coaching services 160 such as personal electronic communications, telephonic communications and the like are choices available to the user. Further, based upon the user's inventory and categorization forms, the coach can leave appropriate messages for the particular user.

As noted above, the system 100 can also be used off-line, in a paper format. In addition, the interaction with other system users can be off-line and in person, at group meetings and help-groups. Other services that are offered on line, such as coaches, are also available in-person. Hence, a system 100 user has the option of accessing and using the system completely on-line, completely off-line, or using the system partly on-line and partly off-line. Therefore, a user can access the various forms, instructions, and assistance on-line, or off-line through clinics, seminars, workshops and the like.

The system 10, 100 can be offered by employers, educational institutions, the military, and others that are interested in providing life management skills and reducing the stress of people in their respective organization, and their families. The system 10, 100 can be an effective tool for reducing stress at work by encouraging employees and managers to participate in the system and create their respective plans. Further, the system can be used personally; by families, spouses, children, couples, and friends. In addition, the system and method 10, 100 can be utilized and tailored for upcoming special events that may produce anxiety and stress, such as holidays, weddings, family get-togethers, and the like. Alternatively, as noted above, an individual can use the system 10, 100 as an individual.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents.

1. A method for generating a stress relief plan comprising:
identifying factors with which a user interacts;
listing the factors with which the user interacts into an inventory form;
making notations and/or making journal entries into a journal form regarding experiences with the factors;
entering the factors into a categorization grid, based at least in part on the notations and/or journal entries;
developing rules around the factors; and developing a plan for reducing, changing or eliminating exposure to factors and/or impact of factors located in a negative category in the categorization grid and increasing exposure to factors and/or impact of factors located in a positive category in the categorization grid.

2. The method of claim 1 wherein the factors comprise persons, places or things.

3. The method of claim 1 further including categorizing the factors into either a negative category comprising a red/carbon monoxide category and a yellow/carbon dioxide category, or into a positive category comprising a green/oxygen category.

4. The method of claim 1 wherein the inventory form, journal form, categorization grid, rules and plan are accessed electronically through the Internet.

5. The method of claim 1 wherein the inventory form, journal form, categorization grid, rules and plan are available in paper form.

6. The method of claim 1 further comprising electronic-based communications among users of the method, such that the users can communicate with each other through electronic medium selected from the group consisting of e-mail and the Internet.

7. The method of claim 1 further comprising customized coaching wherein a method of communication between the user and a coach is selected from the group consisting of electronic communications and telephonic communications.

8. The method of claim 1 further comprising providing the user with messages in visually perceptible form on a daily basis.

9. The method of claim 1 further comprising in-person communications among users of the method, such that the users can communicate with each other through group meetings.

10. A computer readable medium having computer executable instructions to cause a computer to perform a method comprising:
electronically displaying an inventory form adapted to receive a user's input regarding factors and influences with which the user interacts;
electronically displaying a journal form adapted to receive a user's observations and entries regarding the factors and influences; and
electronically displaying a categorization grid, adapted to receive a user's entries based at least in part on the journal entries, wherein the user categorizes the factors and influences.

11. The system of claim 10 further comprising electronically displaying a rule generation form adapted to receive a user's entries for setting rules, guidelines, and limits for activities and limits with respect to factors identified in the categorization grid.

12. The system of claim 10 further comprising electronically displaying a plan form adapted to receive a user's entries for implementing the rules and reducing, changing or eliminating exposure to factors and/or impact of factors located in a negative category in the categorization grid and increasing exposure to factors and/or impact of factors located in a positive category in the categorization grid.

13. The system of claim 12 wherein the categorization grid comprises a red/carbon monoxide category encompassing negative factors, a yellow/carbon dioxide category encompassing negative factors that are not as negative as the red category factors, and a green/oxygen category encompassing positive factors.

14. The system of claim 10 wherein the inventory form, the journal form, and the categorization grid are accessible through the Internet.

15. The system of claim 10 further comprising coaching assistance wherein the coaching assistance is provided via a communication method selected from the group consisting of electronic communication, telephonic communication, and in-person communication.

16. The system of claim 10 further comprising electronic-based communication among users of the system, the electronic based communication selected from the group consisting of e-mail and the Internet.

17. A processor-driven life management system for subscribers comprising:
subscriber registration and validation software;
on-line forms for prompting a subscriber to input and categorize factors and influences with which the subscriber interacts, and to generate rules and implementation plans;
a database for storing individual subscriber input and subscriber implementation plans;
a coaching module facilitating electronic-based communication with the subscriber; and
a module for facilitating electronic-based communication among subscribers.

18. The system of claim 17 wherein the influences and factors are people, places and things, and wherein the influences and factors are placed in selected on-line forms in categories comprising red/carbon monoxide and yellow/carbon dioxide representing negative factors, and green/oxygen representing positive factors.

19. The system of claim 17 wherein the module for electronic-based communication among subscribers facilitates a communication method selected from the group consisting of e-mail and Internet chat-room.

20. The system of claim 17 wherein the on-line form for generating rules assists the subscriber in developing guidelines for activities and limits with respect to factors and influencers identified in a categorization grid.
